(19) United States
(12) Patent Application Publication
(10) Pub. No.: US 2024/0177523 A1
(43) Pub. Date: May 30, 2024

(54) System and Methods of Predicting Personality and Morals through Facial Emotion Recognition

(71) Applicant: Peter A. Gloor, Cambridge, MA (US)

(72) Inventor: Peter A. Gloor, Cambridge, MA (US)

(21) Appl. No.: 17/890,617

(22) Filed: Aug. 18, 2022

(51) Int. Cl. G06V 40/16; G06V 40/20

(52) U.S. Cl. CPC G06V 40/176; G06V 40/20

(57) ABSTRACT

Disclosed in the present invention is a human personality and morals prediction system. In particular, the invention discloses a system of predicting personality and morals through facial emotion recognition. A computer-implemented system for predicting personality and morals through facial emotion recognition, comprising a machine learning system that predicts personality characteristics of individuals on the basis of their face. Also disclosed are methods of tracking the emotional response of the individual's face through facial emotion recognition (FER) while watching a series of 15 short videos of different genres; and calibration of emotional responses for analysis through their facial expression.

### TECHNICAL FIELD

The present invention generally, relates to human personality and morals and in particularly to a system and methods of predicting personality and morals through facial emotion recognition.

### BACKGROUND ART

Humans judge other humans based on their face images, predicting personality traits (such as generosity, reliability), capabilities (intelligence, precision) even guessing professions (a teacher, a care-giver, a lawyer) from a face image alone. Psychological research has found a high degree of correlation in such judgments (different people interpreting the same face image in a similar manner). Moreover, psychological research has also found a certain degree of correlation between face appearances and ground truth or real-world performance (successful CEO, winning martial arts fighter, etc).

Psychologists, counsellors, coaches, therapists gather information on one's personal traits and those of others to analyse and advise on interactions in the social and business domains. However, it is clear that different people have different judgment capabilities, some judgments may be pure prejudice, and in any case it is impractical to rely on human judgment to process high-volumes of data in an efficient and repeatable manner.

In the prior art, face image analysis techniques have been provided to detect the emotional state of a person—e.g. anger/happiness/sadness by tracking or recognizing an expression defined by certain deformation of the face image as measured for example from the relative distances between facial landmarks, e.g., as disclosed by US Patent Application No. 2011/0141258 “emotion recognition method and system thereof”. In contrast, the present invention measures traits or fixed personality characteristics which do not change over time. Actually, a neutral expression is preferred, as non-neutral expression, in particular an extreme emotional state, may distort the usual appearance of the person being analysed.

Existing systems for personality trait prediction from text does the prediction separately for different sources of data like social media, call detail records, email. There are systems available that discloses multiple ways of performing personality prediction from text. The detection of different personality from text has been used widely across multiple fields, for example, one of the main areas, hiring process wherein personality prediction from text is currently used for determining: whether a personality is suitable for testing job, research manager, etc. . . . ?, whether he/she a good team player?.

Personality prediction also helps to understand state of personality namely confused, organized, abstract or definitive. There are different techniques for predicting the personality from text. A person may typically have more than one personality trait but current systems are not able to identify which is the most prominent and less significant trait from the multiple personality traits identified.

The limitation of the current systems is how to correlate the information on the multiple personality traits that have been identified from the text from different sources of data. This limitation stems from the fact that the current systems do not go into deep levels like analysis of texts based on different topics and correlating them based on the prominent personality traits. Further, current systems do not know how to automate the above process in an efficient manner according to need and for benefit of different businesses.

Currently computer systems have separate systems for facial recognition, and speech recognition. These separate systems work independently of each other and provide separate output information which is used independently. For emotion recognition and modelling of user characteristics simply using one system may not provide enough contextual information to accurately model the emotions or behaviour characteristics of the user.

In the field of predicting personality categories based on artificial neural networks, studies to predict the speaker's personality by applying personality models used in the field of psychology such as Big-Five or MBTI are being actively conducted. There is still a lack of research conducted on methods for predicting and recognizing. For example, in the Big-Five model, in utterances that show neuroticism personality traits, antagonistic personality traits are often expressed together.

In addition, there is a characteristic that the speaker's personality traits appear prominently when the speaker expresses his or her emotions. So far, no research has been conducted on using information related to the speaker's emotions in predicting personality traits.

The US patent number US20190341025A1 describes an integrated understanding of user characteristics by multimodal processing. The system and method for multimodal classification of user characteristics is described. The method comprises receiving audio and other inputs, extracting fundamental frequency information from the audio input, extracting other feature information from the video input, classifying the fundamental frequency information, textual information and video feature information using the multimodal neural network.

The U.S. Ser. No. 10/079,029B2 discloses a system for Generating communicative behaviors for anthropomorphic virtual agents based on user's affect. The Systems and methods for automatically generating at least one of facial expressions, body gestures, vocal expressions, or verbal expressions for a virtual agent based on emotion, mood and/or personality of a user and/or the virtual agent are provided. Systems and method for determining a user's emotion, mood and/or personality are also provided.

The international patent application number WO2021153830A1 reveals a method for recognizing personality from uttered conversation, and system for same. The system recognizes personality from an uttered conversation, and a method for same. According to an embodiment, a system, implemented with a computer, for recognizing personality from an uttered conversation comprises at least one processor for executing computer-readable instructions, wherein the at least one processor includes: a pre-processing unit which isolates, from an input conversation, a target utterance from which personality is to be recognized, as well as an utterer that has uttered the target utterance; an emotion information prediction unit which predicts the emotion of the utterer that has uttered the target utterance, on the basis of the target utterance; an utterance personality prediction unit which predicts the category of the personality of the utterer on the basis of the target utterance; and an emotion-personality dependence analysis unit which analyzes the dependence between the predicted emotion and the predicted personality category to recognize the personality of the utterer.

The US patent number U.S. Pat. No. 8,825,764B2 discloses a process of determining user personality characteristics from social networking system communications and characteristics. The social networking system obtains linguistic data from a user's text communications on the social networking system. For example, occurrences of words in various types of communications by the user in the social networking system are determined. The linguistic data and non-linguistic data associated with the user are used in a trained model to predict one or more personality characteristics for the user. The inferred personality characteristics are stored in connection with the user's profile, and may be used for targeting, ranking, selecting versions of products, and various other purposes.

The U.S. Ser. No. 10/855,712B2 describes a detection of anomalies in a time series using values of a different time series. In some implementations, sequences of time series values determined from machine data are obtained. Each sequence corresponds to a respective time series. A plurality of predictive models is generated for a first time series from the sequences of time series values. Each predictive model is to generate predicted values associated with the first time series using values of a second time series.

For each of the plurality of predictive models, an error is determined between the corresponding predicted values and values associated with the first time series. A predictive model is selected for anomaly detection based on the determined error of the predictive model.

Transmission is caused of an indication of an anomaly detected using the selected predictive model.

However, all the above cited prior art do not teach the same subject matter being taught in the present invention.

It against this background that there is need to develop and avail a user-friendly process of predicting personality and morals through facial emotion recognition. Thus, there is a need in the art, for a system that can utilize multiple modes of input to predict user emotion and/or moral characteristics.

### OBJECTS OF THE INVENTION

The main object of the present invention is to provide a system for predicting personality and morals through facial emotion recognition.

The other object of the present invention is to provide a series of method of predicting personality and morals through facial emotion recognition.

### SUMMARY OF THE INVENTION

Disclosed in the present invention is a system and methods of predicting personality and morals through facial emotion recognition. The invention introduces a machine learning system that predicts personality characteristics of individuals on the basis of their facial expression.

In one preferred embodiment, the invention does so by tracking the emotional response of the individual's face through facial emotion recognition (FER) while watching a series of 15 short videos of different genres. To calibrate the system, inventors invited 85 people to watch the videos, while their emotional responses were analysed through their facial expression. At the same time, these individuals also took four well-validated surveys of personality characteristics and moral values: the revised NEO FFI personality inventory, the Haidt moral foundations test, the Schwartz personal value system, and the domain-specific risk-taking scale (DOSPERT).

In another preferred embodiment, the invention discloses a computer-implemented system for predicting personality and morals through facial emotion recognition, comprising at least one processor implemented to execute computer-readable instructions including, the at least one process, a pre-processing unit for classifying a target facial emotion recognition that is a target of personality recognition and a target who showed the face from the inputted facial emotion recognition; In another preferred embodiment, the invention reveals that personality characteristics and moral values of an individual can be predicted through their emotional response to the videos as shown in their face, with an accuracy of up to 86% using gradient-boosted trees.

In another preferred embodiment, the invention reveals that different personality characteristics are better predicted by different videos, in other words, there is no single video that will provide accurate predictions for all personality characteristics, but it is the response to the mix of different videos that allows for accurate prediction.

In another embodiment, the invention avails a computer-implemented system for predicting personality and morals through facial emotion recognition, comprising at least one processor implemented to execute computer-readable instructions including, the at least one process, a pre-processing unit for classifying a target facial emotion recognition that is a target of personality recognition and a target who showed the face from the inputted facial emotion recognition; an emotion information prediction unit for predicting a personality of a target based on the facial emotion recognition. a facial emotion recognition personality predicting unit for predicting a personality category of the target based on the target facial emotion recognition; and an emotion-personality dependency analysis unit for recognizing the target's personality by analyzing the dependence between the predicted emotion and the predicted personality category

The teachings of the present invention can be readily understood by considering the following detailed description in conjunction with the accompanying drawings.

### BRIEF DESCRIPTION OF FIGURES

FIG. 1 represents a setup of our system with video website and four online surveys.

FIG. 2 represents the relationships between videos, emotions, and personality (top), and between emotions and individual traits (bottom).

FIG. 3 represents a feature importance for predicting conservation.

FIG. 4 represents a feature importance for predicting authority/respect.

FIG. 5 represents a feature importance for predicting conscientiousness.

FIG. 6 represents a feature for predicting health likelihood.

FIG. A1 represents feature importance for predicting transcendence.

FIG. A2 represents feature importance for predicting fairness/reciprocity.

FIG. A3 represents feature importance for predicting harm/care

FIG. A4 represents feature importance for predicting in-group loyalty.

FIG. A5 represents feature importance for predicting purity/sanctity.

FIG. A6 represents feature importance for predicting agreeableness.

FIG. A7 represents feature importance for predicting extraversion.

FIG. A8 represents feature importance for predicting neuroticism.

FIG. A9 represents feature importance for predicting openness.

FIG. A10 represents feature importance for predicting ethical likelihood.

FIG. A11 represents feature importance for predicting ethical perceived.

FIG. A12 represents feature importance for predicting financial likelihood.

FIG. A13 represents feature importance for predicting financial perceived.

FIG. A14 represents feature importance for predicting health perceived.

FIG. A15 represents feature importance for predicting recreational likelihood.

FIG. A16 represents feature importance for predicting recreational perceived.

FIG. A17 represents feature importance for predicting social likelihood.

FIG. A18 represents feature importance for predicting social perceived.

FIG. 7 is Table 1. List of 15 movie snippets.

FIG. 8 is Table 2. Descriptive statistics of individual traits.

FIG. 9 is Table 3. Regression models for the Big Five personality traits.

FIG. 10 is Table 4. Regression models for the DOSPERT scale values.

FIG. 11 is Table 5. Regression models for conservation and transcendence.

FIG. 12 is Table 6. Regression models for the Haidt moral values.

FIG. 13 is Table 7. Accuracy of Xgboost models.

FIG. 14 is Table A1. Pearson's correlation coefficients.

FIG. 15 is Table A1. Pearson's correlation coefficients, continued

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another.

Can we really “read the mind in the eyes” ? Moreover, can AI assist us in this task?

The present invention attempts to answer these two questions by introducing a machine learning system that predicts personality characteristics of individuals on the basis of their face. It does so by tracking the emotional response of the individual's face through facial emotion recognition (FER) while watching a series of 15 short videos of different genres. To calibrate the system, the inventor invited 85 people to watch the videos, while their emotional responses were analyzed through their facial expression. At the same time, these individuals also took four well-validated surveys of personality characteristics and moral values: the revised NEO FFI personality inventory, the Haidt moral foundations test, the Schwartz personal value system, and the domain-specific risk-taking scale (DOSPERT). The NEO-FFI-3 is a 60-item version of the NEO-PI-3 that provides a quick, reliable, and accurate measure of the five domains of personality (Neuroticism, Extraversion, Openness, Agreeableness, and Conscientiousness). All updates made in the NEO-PI-3 are reflected in this instrument.

In a preferred embodiment, the invention reveals that personality characteristics and moral values of an individual can be predicted through their emotional response to the videos as shown in their face, with an accuracy of up to 86% using gradient-boosted trees. We also found that different personality characteristics are better predicted by different videos, in other words, there is no single video that will provide accurate predictions for all personality characteristics, but it is the response to the mix of different videos that allows for accurate predict

### Emotional Response Shows Individual Value System

On the basis of their moral values, humans experience or show different emotions in response to an external stimulus. Emotional actions triggered through moral values are called “moral affect” [12]. Moral affect-such as shame, guilt, and embarrassment is linked to moral behaviour, leading to prohibitions against behaviour that is likely to have negative consequences for the well-being of others [13]. For instance, on the basis of the personal value system, an individual might have shown a different emotional reaction when President Trump was announcing the construction of a wall to keep out asylum seekers from Mexico [14]. Both philosophers [14] and psychologists [2] have investigated this link between morals and emotions.

In order to experience that something is wrong, one needs to have a feeling of disapproval towards it [14]. To measure this feeling of disapproval, thus far, technologies such as tracking the hormone level in blood or saliva have been used. For instance, it has been shown that the hormone level in saliva of homosexual and heterosexual men, when shown pictures of two men kissing, is radically different [15]. The researchers showed homosexual and heterosexual men in Utah pictures of same-sex public display of affection, plus disgusting images, such as a bucket of maggots. They used the link between disgust and prejudice, which has been shown to be capable of eliciting responses from the sympathetic nervous system, one of the body's major stress systems [16]. Salivary alpha-amylase is considered a biomarker of the sympathetic nervous system that is especially responsive to inductions of disgust.

The researchers found that the difference in salivary alpha-amylase explained the degree of sexual prejudice against homosexuality among their test subjects, similar to their disgust about a bucket of maggots. In other words, their emotional response, measured through salivary alpha-amylase, indicated their moral values. Instead of measuring negative (and positive) emotions through the saliva, in our research, we measured it through face emotion recognition, maintaining the existence of a similar link between emotional response and moral values.

Reading Personality Attributes from Facial Characteristics

Studying the relationship between facial and personality characteristics has a long history going back to antiquity. The book “Physiognomics”, discussing the relationship between facial appearance and character, was written 300 BC in Aristotle's name, but is today attributed to a different author by most researchers. Swiss poet, writer, philosopher, physiognomist, and theologian Johann Caspar Lavater published between 1775 and 1778 his magnum opus on physiognomy, “Physiognomische Fragmente zur Beforderung der Menschenkenntnis und Menschenliebe” (Physiognomic fragments to promote knowledge of human nature and human love) [17], which cataloged leaders and ordinary men (there were very few pictures of women) of his time by their facial shape, or what he called their “lines of countenance”. Lavater even invented an apparatus for taking facial silhouettes to quickly capture the characteristics of a face, and thus the personality of the person.

Later, statistician Francis Galton tried to define physiognomic characteristics of health, beauty, and criminology by creating composites through overlaying pictures of archetypical faces [18]. Italian criminologist and scientist Cesare Lombroso continued this work by defining facial measures of degeneracy and insanity including facial angles, “abnormalities” in bone structure, and volumes of brain fluid [19]. For the better part of the 20th century, scientists derogatively titled physiognomics as “pseudoscience”. This changed towards the end of the 20th century. While early physiognomists from Aristotle to Lombroso tried to develop manually assembled frameworks, AI and deep learning has given a huge boost to this emerging field.

Recently, physiognomics has been experiencing renewed interest by researchers, particularly by comparing facial width to height ratio with personality. The theory of “facial width to height ratio” (fWHR) posits that men with higher “facial width to height ratio”, that means with broader, rounder faces, are more aggressive, while men with thinner faces are more trustworthy [20-23]. Recognizing these features automatically through facial emotion recognition has come a long way since the early days of the facial action coding system, thanks to recent advances in AI and deep learning. A large amount of research has addressed the issue of recognizing personality characteristics from facial attributes. For instance, ChaLearn “Looking at People First Impression Challenge” released a dataset with 10,000 15 s videos with faces (https://chalearnlap.cvc.uab.cat/dataset/20/description/, accessed on 21 Dec. 2021) [24], asking participants in the challenge to identify the FFI personality characteristics [8] of the person on the video, and their age, ethnicity, and gender attributes [25].

The problem with this dataset is that the personality attributes had been added by Amazon Mechanical Turkers, which sometimes leads to a biased ground truth, as it is based on guesswork by humans (the turkers). As was mentioned in the introduction, it has been shown by other researchers that accuracy of human labelers in recognizing emotions is only incrementally better than guesswork at slightly below 50 percent [2]. Nevertheless, the winners of the ChaLearn challenge have achieved impressive accuracy on this pre-labeled dataset to correctly predict the FFI personality characteristics at over 91% [26]. However, it would be better to have true ground truth on the personality characteristics of the subjects on the video. In another project using Facebook likes, where ground truth was available, the researchers showed that the computer was actually better in recognizing personality characteristics than work colleagues, who reached only 27% accuracy, while the computer achieved 56% accuracy [3]; spouses were the most accurate at 58%.

The personality characteristics had been collected from 86,220 users through a personality survey on Facebook and were predicted through Facebook likes using regression. Earlier work has used facial expression of the viewer to measure the quality of a video [27-29]. We extend this work to not only measure the degree of enjoyment of the viewer, but the personality characteristics and moral values of the viewer-motivated by the insight that facial expressions will mirror moral values-combining face emotion recognition with ground truth obtained directly from surveys taken by the individual.

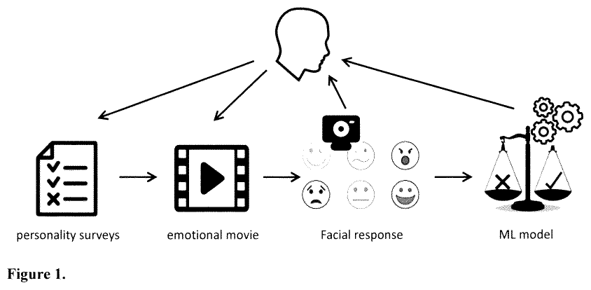

In several embodiments of the present invention according to FIGS. 1-6, FIGS. 1A-18A and FIGS. 7-15, the method teaches about human personality and morals and in particularly to a system and methods of predicting personality and morals through facial emotion recognition.

FIG. 1 represents a setup of our system with video website and four online surveys of the invention. In this embodiment, the user fills out four morality and personality surveys 101. Then user views 15 emotionally provoking movie snippets 102 which provokes facial response to movie snippets is recorded with Webcam 103. ML model trained with emotions from movies and morals from surveys automatically predicts morals at step 104.

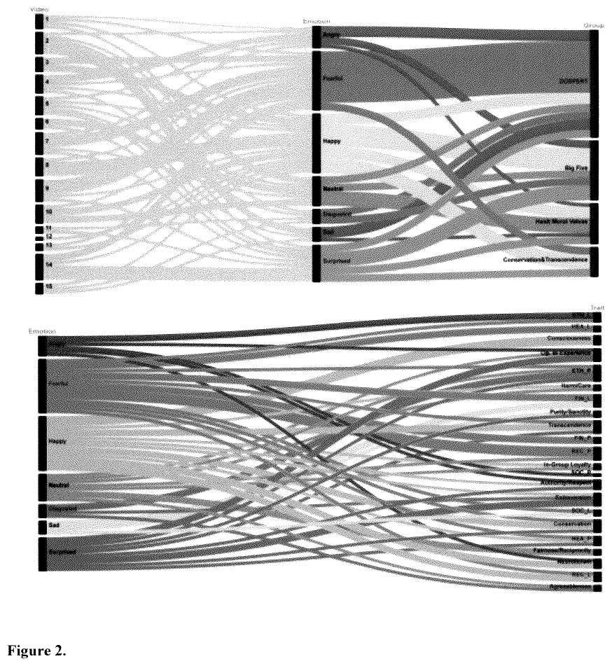

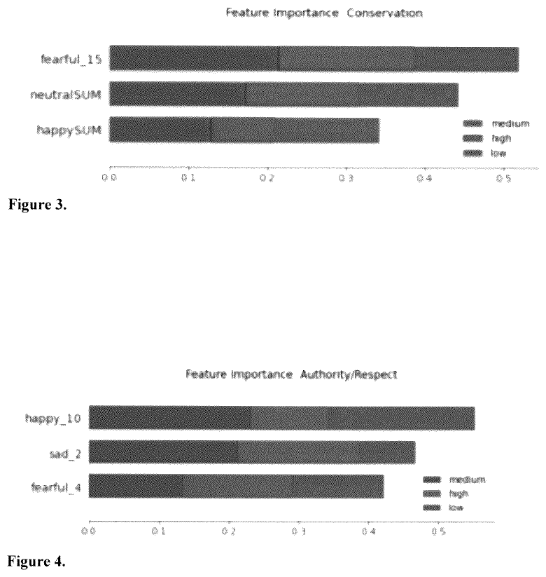

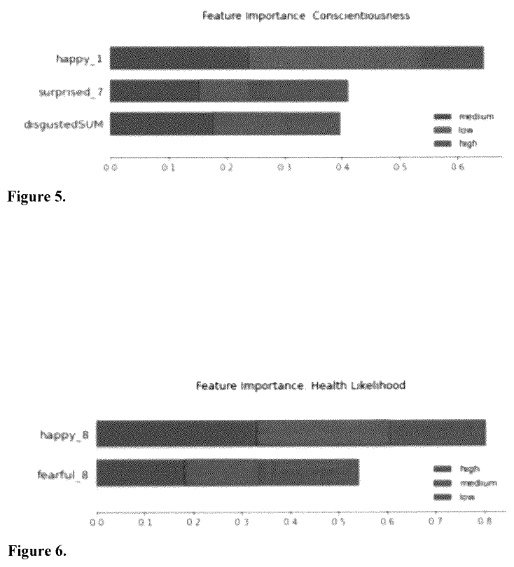

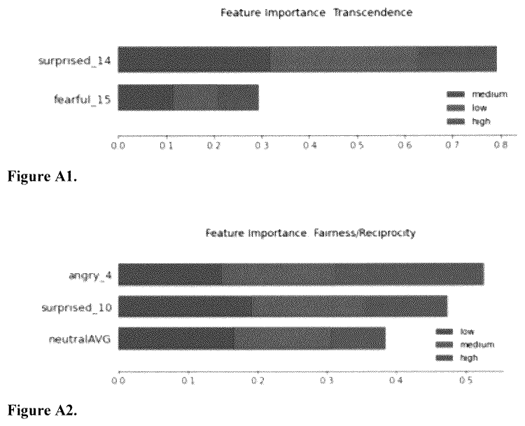

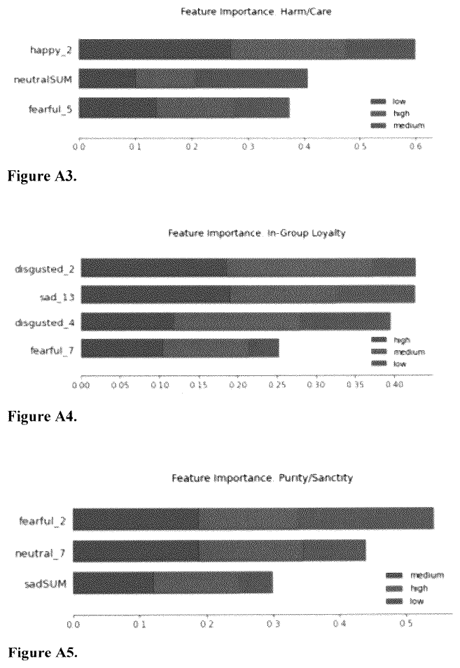

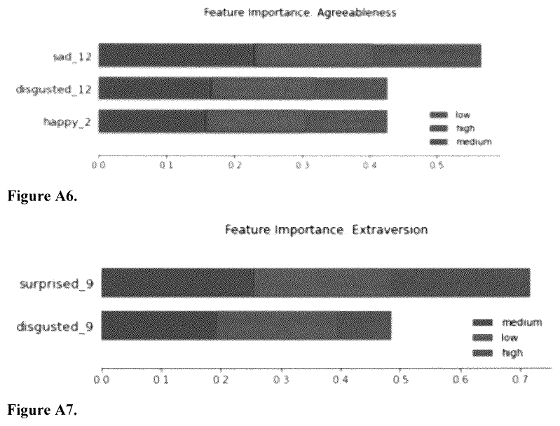

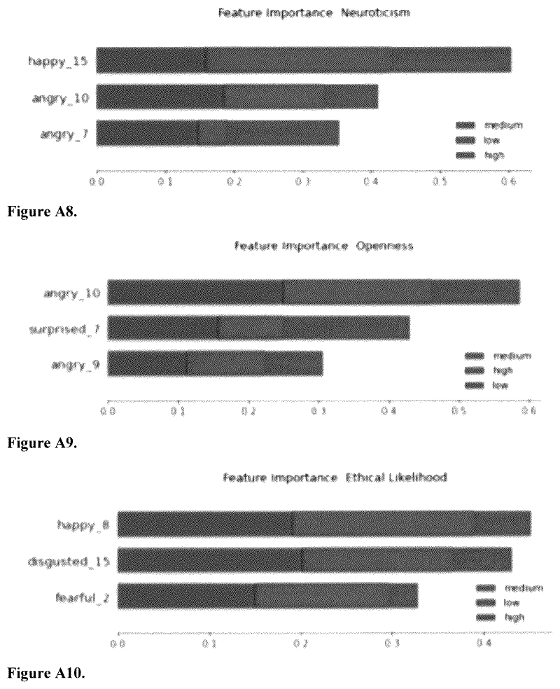

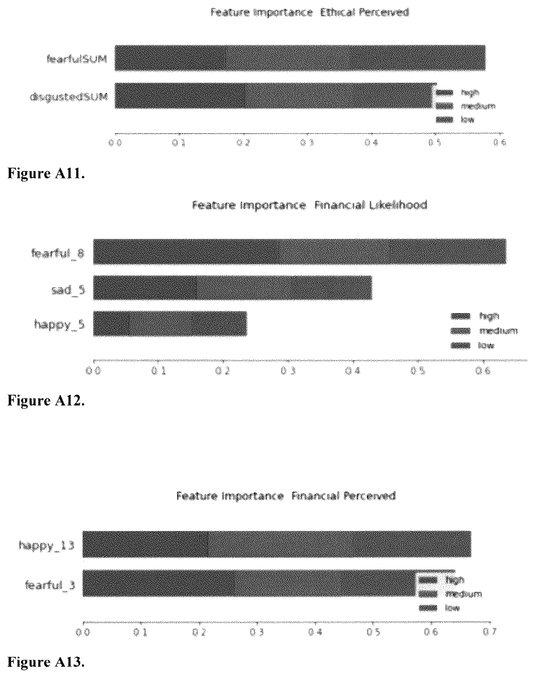

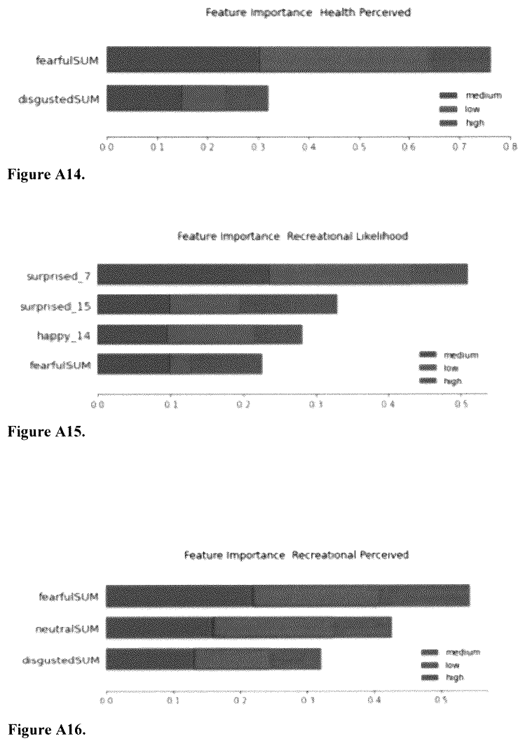

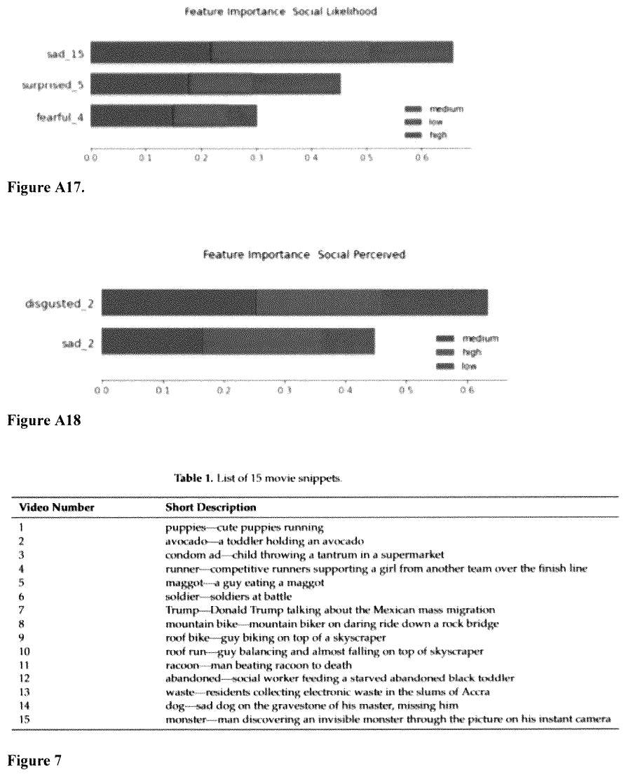

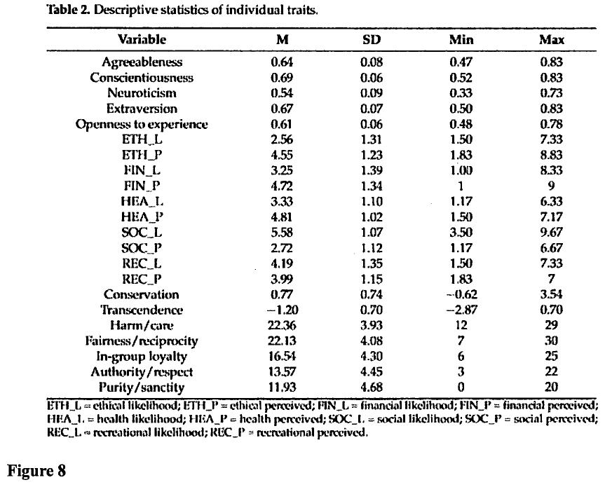

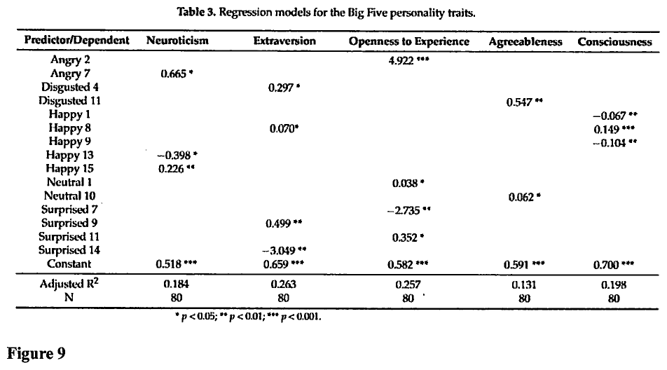

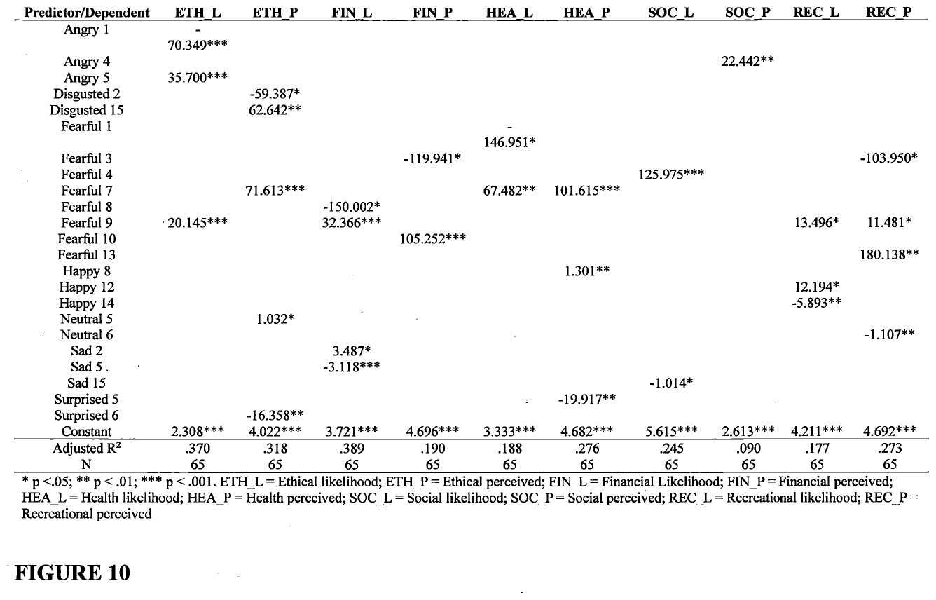

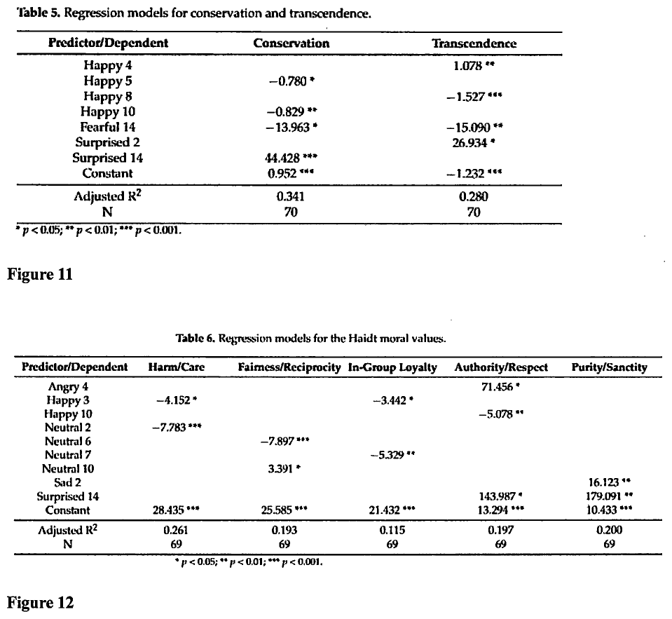

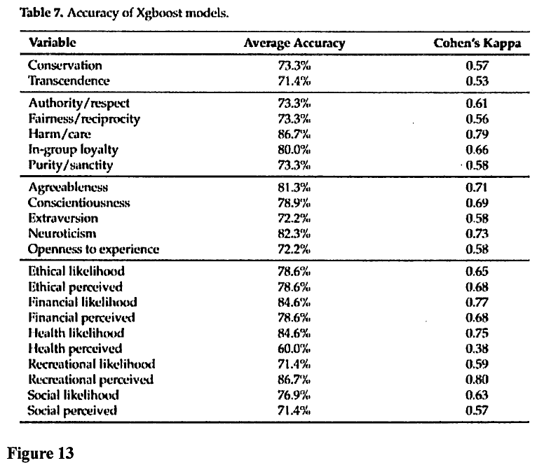

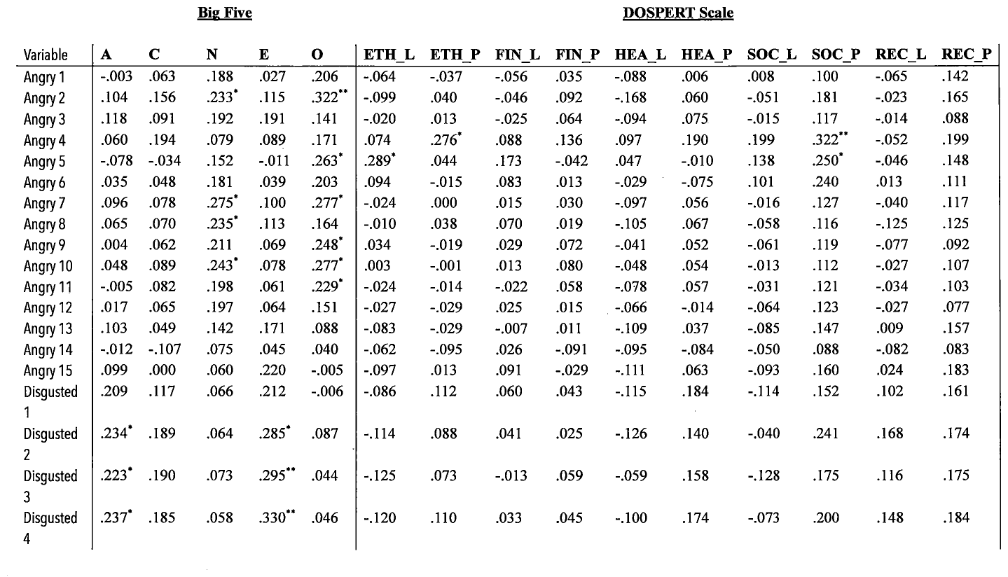

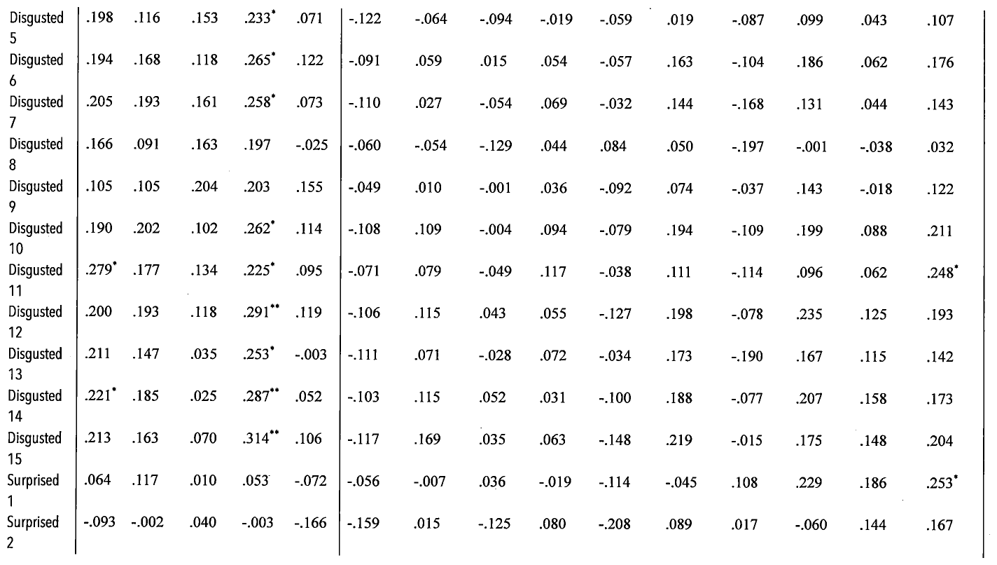

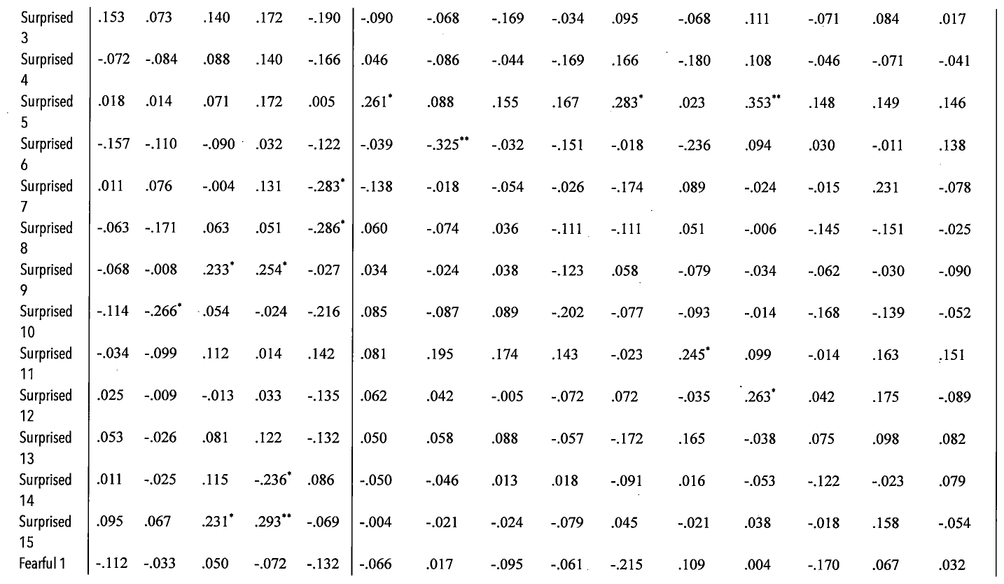

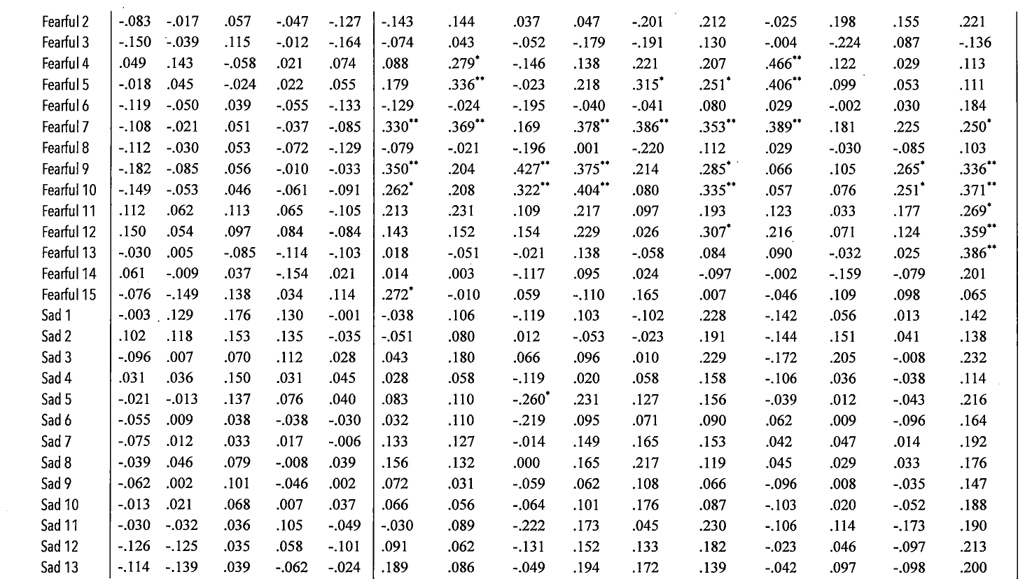

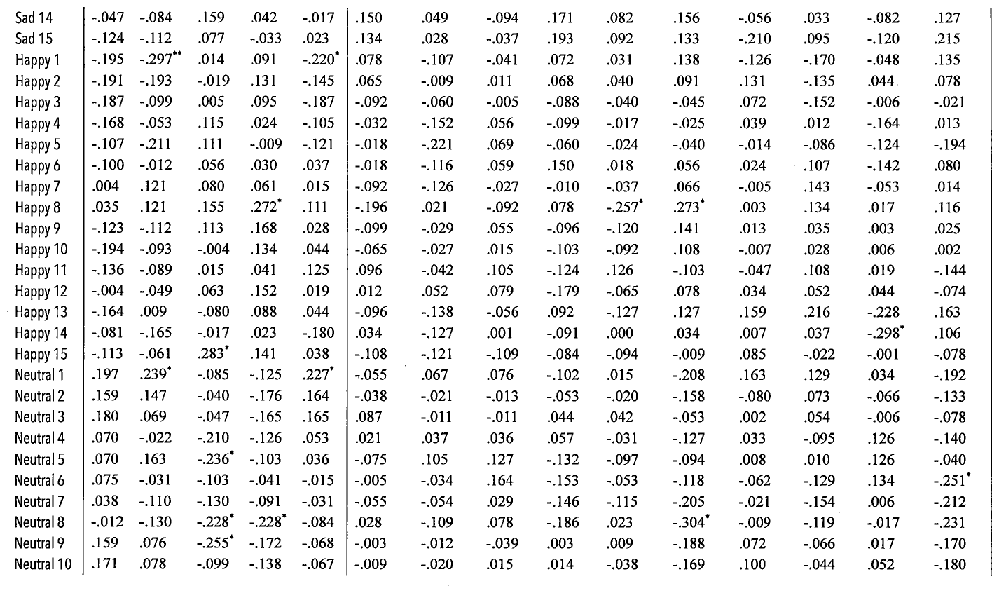

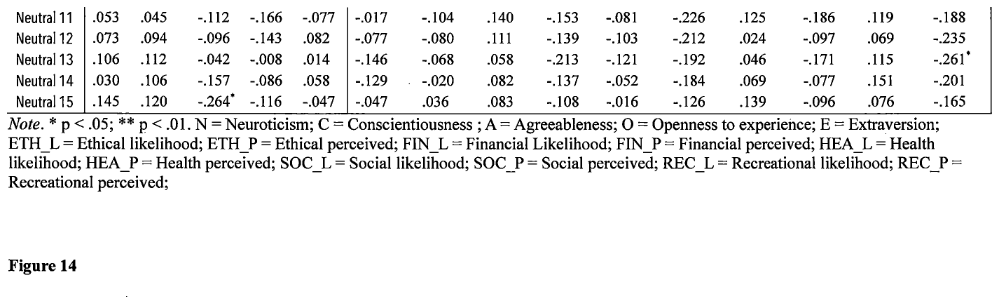

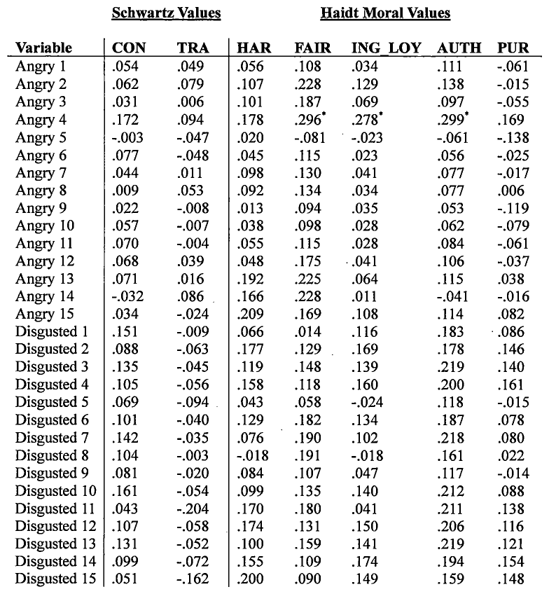

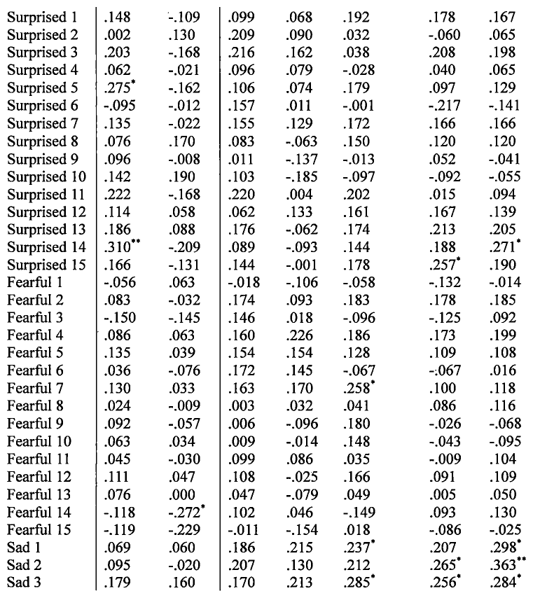

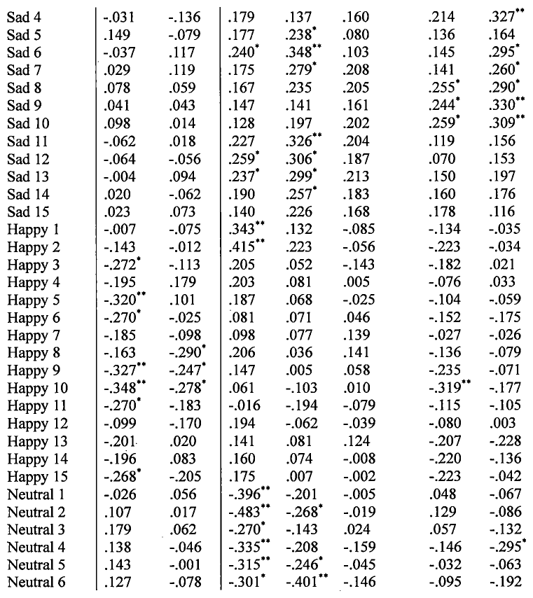

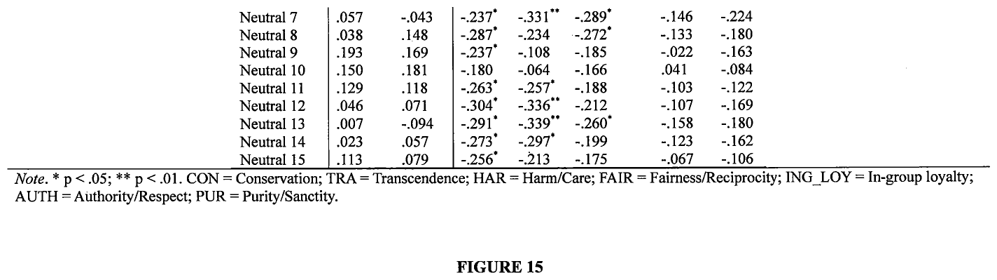

FIG. 2 represents alluvial diagrams illustrating the significant relationships between videos, emotions, and personality (top), and between emotions and individual traits (bottom). FIG. 3 represents a feature importance for predicting conservation while FIG. 4 represents a feature importance for predicting authority/respect. In FIG. 5, the invention shows a feature importance for predicting conscientiousness. In FIG. 6, the invention teaches of a feature for predicting health likelihood.

In another set of embodiment, FIG. A1 represents feature importance for predicting transcendence. FIG. A2 represents feature importance for predicting fairness/reciprocity while FIG. A3 represents feature importance for predicting harm/care. FIG. A4 represents feature importance for predicting in-group loyalty. FIG. A5 represents feature importance for predicting purity/sanctity. Whereas FIG. A6 represents feature importance for predicting agreeableness, FIG. A7 represents feature importance for predicting extraversion. In FIG. A8 represents feature importance for predicting neuroticism. FIG. A9 represents feature importance for predicting openness. FIG. A10 represents feature importance for predicting ethical likelihood.

Further, FIG. All represents feature importance for predicting ethical perceived by the invention. While FIG. A12 represents feature importance for predicting financial likelihood, FIG. A13 represents feature importance for predicting financial perceived. FIG. A14 represents feature importance for predicting health perceived. FIG. A15 represents feature importance for predicting recreational likelihood. FIG. A16 represents feature importance for predicting recreational perceived. While FIG. A17 represents feature importance for predicting social likelihood, FIG. A18 represents feature importance for predicting social perceived.

Further, in FIG. 7, the invention avails Table 1 showing a list of 15 movie snippets. FIG. 8 presents Table 2 that shows descriptive statistics of individual traits. FIG. 9 provides Table 3 that demonstrates regression models for the Big Five personality traits. FIG. 10 shows Table 4 for regression models for the DOSPERT scale values. FIG. 11 provides Table 5 that demonstrates regression models for conservation and transcendence. FIG. 12 is Table 6 for regression models for the Haidt moral values. FIG. 13 is Table 7 showing accuracy of Xgboost models. FIG. 14 is Table A1 for Pearson's correlation coefficients, while FIG. 15 is Table A1A for Pearson's correlation coefficients.

### Methodology—Recording Emotions

Our approach extends existing systems by not only measuring video quality, but moral values and personality of the viewers, as it uses real ground truth on personality characteristics and moral values for prediction by asking the people whose faces are recorded while watching a sequence of 15 emotionally touching video segments to also fill out a series of personality characteristics tests.

For measuring facial emotions, the system consists of a website (facerecognition.galaxyadvisors.com) accessed on 21 Dec. 2021) where the participant watches a sequence of 15 videos (FIG. 1). Table 1 of FIG. 7 lists the 15 movie snippets, at a total length of 9 min 22 s, that are shown to users on the website, while the emotions of their faces are recorded after they have given informed consent that their anonymized emotions will be recorded; no video of the face is recorded.

The 15 video snippets show controversial scenes with the aim of generating a wide range of emotions in respondents [30]. We use the face-api.js tool (https://justadudewhohacks.github.io/face-api.js/docs/index.html, accessed on 21 Dec. 2021), which employs a convolutional neural network with a ResNet-34 architecture [31], to recognize the user's facial emotions in each frame (up to 30 times per second) of the user's web cam. The tracked emotions are joy, sadness, anger, fear, surprise, and disgust [32]. In addition, a seventh emotion “neutral” was added, which greatly increases machine learning accuracy when none of the six Ekman emotions can be recognized.

### Measuring Personality and Morals of the Viewers

Our dependent variables are collected through four well-validated personality and moral values assessments. The user is asked on the same website where the videos are shown to fill out four online surveys for the revised NEO FFI personality inventory, the Haidt moral foundations test, the Schwartz personal value system, and the domain-specific risk-taking scale (DOSPERT). The OCEAN (Openness, Conscientiousness, Extroversion, Agreeability, Neuroticism) personality characteristics are measured with the Neo-FFI [8] survey. Risk-preference is measured by the Domain-Specific Risk-Taking (DOSPERT) survey [11], which assesses disposition to take risks in five specific domains of life (ethical, financial, recreational, health, and social). It measures both the willingness to take risks and the individual perception of an activity as risky.

Moral foundational values are measured with the Haidt moral foundations survey [9]. It measures the moral values of the respondent in five categories (care, fairness, loyalty, authority, and sanctity). In addition, the two dimensions of Conservation and Transcendence also are assessed through a survey [10,33]. The Schwartz values have been validated in many countries around the world [34].

### Results—Emotional Response Predicted Values

We found that all four dimension of a personality, FFI characteristics, DOSPERT risk taking, moral foundations, and Conservation and Transcendence (Schwartz values), can be predicted on the basis of the emotions shown while watching the 15 different video segments. Table 2 of FIG. 8 shows the descriptive statistics of our dependent variables for all four dimensions of a personality, listing the individual traits we mapped through psychometric tests.

In Table A1 of FIG. 14, the invention shows the Pearson's correlation coefficients of individual traits with the different emotions experienced while watching the videos. Neither commenting on each single association and its significance, nor investigating the possible reasons behind associations, is in the scope of this research. Rather it was intended to show the possibility of predicting individual traits, based on the differential emotional response of individuals exposed to the same set of stimuli, by considering automatically recognized emotions through artificial intelligence. The preliminary result of correlations—a suggested association between individual differences and people's emotional responses—is confirmed by the regression models presented in Tables 3-6 of FIGS. 9-12. For each set of dependent variables, they show the best model, i.e., the optimal combination of predictors that can explain the larger proportion of variance. There was no evidence of collinearity problems (evaluated by calculating variance inflation factors). These regressions illustrate the predictability of personality characteristics and morals from facial expression of emotions using conventional statistical methods.

In general, we found that models for some traits-such as conservation, transcendence, and ethical and financial likelihood-had promising adjusted R2 values. In terms of emotions, fear seemed more relevant for the predictions of the DOSPERT scores, whereas happiness seemed more associated with the Big Five personality traits. Being neutral in front of a video can also play a role in determining the individual's personality characteristics. Remember that the facial emotion recognition system returns this value if it cannot assign any other emotion with a sufficiently high threshold, corresponding to the individual sitting in front of the computer with an unmoving face. We also see that different videos triggered a variety of emotional responses, which were possibly useful for the prediction of different traits. All the relationships explored in this study could be further investigated in future research in order to better analyze their meaning from a psychological perspective.

FIG. 2 summarizes findings from the regression models, providing evidence to the importance of each video and emotion for the prediction of individual traits. For example, we can observe that videos number 14, 9, and 2 were those that triggered the most useful emotional responses. Among emotions, fear and happiness were those most used to make predictions, with fear being particularly relevant for the DOSPERT traits.

### Predicting Personality and Morals Using Machine Learning

While correlations and regressions showed promising results, we wanted to complete our analysis to explore non-linear relationships and the possibility of making predictions by using machining learning and considering a test sample (a subset of observations) not used for model training. In particular, we binned the continuous scores of our dependent variables into three classes in order to understand if values were high, medium, or low. Subsequently, we used a gradient boosting approach to make predictions, namely, Xgboost [35]. We trained our models using 10-Fold Cross Validation and the SMOTE technique [36] in order to treat unbalanced classes. ADASYN was also used as an alternative to SMOTE [37], in the cases where this led to improved forecasts. In Table 7 of FIG. 13, the invention presents the results of these forecasting exercises, made on 10% of observations that were held out for testing prediction accuracy

FIG. 2 Illustrates alluvial diagrams illustrating the significant relationships between videos, emotions, and personality (top), and between emotions and individual traits (bottom).

As the table shows, the invention obtained good prediction results, both in terms of average accuracy and Cohen's Kappa. Only for the health perceived trait of the DOSPERT scale did we obtain an accuracy score that was below 70% (60% average accuracy and a Kappa value of 0.38). This confirms our original hypothesis that facial emotion recognition can be used to predict personality and other individual traits. Similarly, to the regression models, different features were more important for the prediction of personality and other individual traits. In order to evaluate the contribution of each feature to model prediction, we used Shapley additive explanations (SHAP) [38,39]. In the following (FIGS. 3-6), we provide some examples, while the remaining charts are shown in Table A1 of FIG. 14. Future Internet 2022, 14, 5 10 of 20 [38,39]. In the following (FIGS. 3-6), we provide some examples, while the remaining charts are shown in Table A1A of FIG. 15.

As the Shapley charts illustrate, again the emotions happiness and fear were found to have the strongest predictive power. However, we cannot make any claim about what emotional response to which movie predicts what personality characteristics. This is not the point of this paper. The point is that “your emotional response predicts your personality characteristics and moral values”. Identification of the most emotionally provocative movies is most likely dependent on the individual personality and values of the viewer, which is also related to local cultures and values. It would therefore be another research project to precisely identify a minimal set of short movies that consistently provoke the most expensive emotions that are the most indicative of an individual's personality and morals.

### Limitations, Future Work, and Conclusions

In this work, we show that Table A1 of FIG. 14 can be used for the task of facial emotion recognition, producing features that can in turn predict people's personality and moral values. Ours is an exploratory analysis with regard to associations found between different individual traits and emotions produced in response to a different set of audio-visual stimuli. These relationships could be further investigated in future research in order to better understand their meaning from a psychological perspective.

Future research should consider more control variables, which we could not collect in our experiment (due to privacy arrangements), such as age, gender, and ethnicity of experiment participants. Similarly, a different set of videos could be taken into account, also looking for the optimal set of stimuli that could produce an emotional response better associable to specific individual differences.

Our research has both practical and theoretical implications. On the theoretical side, it further confirms the insight that moral affect—emotions in response to positive and negative experiences—are at the centre of our ethical values. On the practical side, our approach offers a novel and more honest way to measure personality characteristics, attitudes to risk, and moral values.

As has been discussed above, while humans tend to misjudge personality and moral values of others and themselves, Table AIA of FIG. 15 provides an honest virtual mirror assisting in this task.

The present invention has shown that while humans frequently are incapable of looking behind the facade of the face and “read the mind in the eyes”, artificial intelligence can lend a helping hand to people who have difficulties in this task.

The one or more personality characteristics determined by the user personality estimator are stored in the user profile associated with the user. In one embodiment, the user personality estimator identifies a probability distribution of personality characteristics the user is likely to have from the linguistic features and the retrieved characteristics, and the probability distribution of personality characteristics is stored in the user profile of the user. Storing the distribution of personality characteristics allows the social networking system to account for uncertainty in determination of the user's personality characteristics by storing levels of personality characteristics that the user is likely to have as well as storing alternative levels of personality characteristics that the user may have.

The social networking system uses the personality characteristics associated with the user to select additional content for the user. For example, a user's personality characteristics may be used along with other user information, such as affinities, to select stories for inclusion in the user's newsfeed, to select advertisements for presentation to the user, or to select recommendations of actions for the user to perform social networking system. As another example, stored personality characteristics may be used as targeting criteria for advertisers, allowing advertisement selection to account for particular personality characteristics to increase the likelihood that the user accesses or otherwise positively interacts with a selected advertisement. For example, the product presented in an advertisement may be modified based on one or more of the personality characteristics stored in the user profile.

Additionally, personality characteristics associated with the user may be used to select content for other users of the social networking system. For example, the user's personality characteristics may be used to determine whether content associated with the user is distributed to other users connected to the user.

In one embodiment, the user's personality characteristics may be used to determine whether stories describing actions by the user are included in a news feed of another user or used to determine the location of a story describing an action by the user in the other user's news feed. As another example, the user's personality characteristics may be used when selecting suggested actions for other users that involve the user; as a specific example, the user's personality characteristics may be used to determine whether to recommend that an additional user establish a connection with the user in the social networking system

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

### BEST MODE OF CARRYING OUT THE INVENTION

At its best, the present invention describes a system for predicting personality and morals through facial emotion recognition, comprising a machine learning system that predicts personality characteristics of individuals on the basis of their face; a means of tracking the emotional response of the individual's face through facial emotion recognition while watching a series of at least fifteen short videos of different genres, and a calibration module, wherein emotional responses of people are analyzed through their facial expression as they watch the videos, their emotional responses are analyzed through their facial expression.

The personality characteristics and moral values are within the revised Neuroticism, Extraversion, Openness Five Factors (NEO FFI) personality inventory, the Haidt moral foundations test, the Schwartz personal value system, and the domain-specific risk-taking scale (DOSPERT). The tools for emotional response to the videos personality characteristics and moral values of an individual are predicted through their emotional response to the videos as shown in their face, with an accuracy of up to 86% using gradient-boosted trees. The mix of different videos are enabled to predict different personality characteristics by different videos to allow for accurate prediction.

Also described is a method of predicting personality and morals through facial emotion recognition, comprising steps of:
a. predicting personality characteristics of individuals on the basis of their face using a machine learning system;
b. tracking the emotional response of the individual's face through facial emotion recognition (FER) while watching a series of at least fifteen short videos of different genres;
c. calibrating and analysing users' emotional responses through their facial expression, and
d. validating individuals' surveys of personality characteristics and moral values to the revised NEO FFI personality inventory, the Haidt moral foundations test, the Schwartz personal value system, and the domain-specific risk-taking scale (DOSPERT).

At the step of predicting personality characteristics and moral values, tools for emotional response to the videos personality characteristics and moral values of an individual are applied through their emotional response to the videos as shown in their face, with an accuracy of up to 86% using gradient-boosted trees. At the step of emotional response, a mix of different videos are enabled to predict different personality characteristics for accurate predictions for all personality characteristics.

In another embodiment, the invention describes a computer-implemented system for predicting personality and morals through facial emotion recognition, comprising at least one processor implemented to execute computer-readable instructions including, the at least one process, a pre-processing unit for classifying a target facial emotion recognition that is a target of personality recognition and a target who showed the face from the inputted facial emotion recognition; an emotion information prediction unit for predicting a personality of a target based on the facial emotion recognition, a facial emotion recognition personality predicting unit for predicting a personality category of the target based on the target facial emotion recognition; and an emotion-personality dependency analysis unit for recognizing the target's personality by analyzing the dependence between the predicted emotion and the predicted personality category.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

### INDUSTRIAL APPLICATION

The present invention applies to human personality and morals. In particular, it avails a process of predicting personality and morals through facial emotion recognition. The invention provides a novel system for predicting personality and morals through facial emotion recognition, comprising a machine learning system is able to predict personality characteristics of individuals on the basis of their face. In addition, a method of tracking the emotional response of the individual's face through facial emotion recognition (FER) while watching a series of 15 short videos of different genres; and calibration emotional responses are analysed through their facial expression in a simple and friendly manner.

What is claimed is:

1. A system for predicting personality and morals through facial emotion recognition, comprising:
a machine learning system that predicts personality characteristics of individuals on the basis of their face;
a means of tracking the emotional response of the individual's face through facial emotion recognition while watching a series of at least fifteen short videos of different genres, and
a calibration module, wherein emotional responses of people are analysed through their facial expression as they watch the videos, their emotional responses are analysed through their facial expression.

2. The system for predicting personality and morals as in claim 1, wherein the personality characteristics and moral values are within the revised Neuroticism, Extraversion, Openness Five Factors (NEO FFI) personality inventory, the Haidt moral foundations test, the Schwartz personal value system, and the domain-specific risk-taking scale (DOSPERT).

3. The system for predicting personality and morals as in claim 1, wherein the tools for emotional response to the videos personality characteristics and moral values of an individual are predicted through their emotional response to the videos as shown in their face, with an accuracy of up to 86% using gradient-boosted trees.

4. The system for predicting personality and morals as in claim 1, wherein the mix of different videos are enabled to predict different personality characteristics by different videos to allow for accurate prediction.

5. A method of predicting personality and morals through facial emotion recognition, comprising steps of:
a. predicting personality characteristics of individuals on the basis of their face using a machine learning system;
b. tracking the emotional response of the individual's face through facial emotion recognition (FER) while watching a series of at least fifteen short videos of different genres;
c. calibrating and analysing users' emotional responses through their facial expression, and
d. validating individuals' surveys of personality characteristics and moral values to the revised NEO FFI personality inventory, the Haidt moral foundations test, the Schwartz personal value system, and the domain-specific risk-taking scale (DOSPERT).

6. The method as in claim 5, wherein at the step of predicting personality characteristics and moral values, tools for emotional response to the videos personality characteristics and moral values of an individual are applied through their emotional response to the videos as shown in their face, with an accuracy of up to 86% using gradient-boosted trees.

7. The method as in claim 5, wherein at the step of emotional response a mix of different videos are enabled to predict different personality characteristics for accurate predictions for all personality characteristics.

8. A computer-implemented system for predicting personality and morals through facial emotion recognition, comprising:
a. at least one processor implemented to execute computer-readable instructions including, the at least one process,
b. a pre-processing unit for classifying a target facial emotion recognition that is a target of personality recognition and a target who showed the face from the inputted facial emotion recognition;
c. an emotion information prediction unit for predicting a personality of a target based on the facial emotion recognition.
d. a facial emotion recognition personality predicting unit
e. for predicting a personality category of the target based on the target facial emotion recognition; and
f. an emotion-personality dependency analysis unit for recognizing the target's personality by analysing the dependence between the predicted emotion and the predicted personality category.
